(19) United States
(12) Patent Application Publication
(10) Pub. No.: US 2004/0171325 A1
(43) Pub. Date: Sep. 2, 2004

(54) Chintzed stretch fabrics

(76) Inventor: Malcolm Woods, Cheltenham (GB)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/630,256

(22) Filed: Jul. 30, 2003

(30) Foreign Application Priority Data
Aug. 1, 2002 (GB) 0217909.1

(51) Int. Cl. D03D 15/00; D03D 25/00; D04H 1/00; D04H 13/00; B32B 25/02

(52) U.S. Cl. 442/361; 442/362; 442/364; 442/363; 428/296.7

(57) ABSTRACT

The invention provides stretch fabrics and articles from the fabrics comprising at least a region consisting of a single thickness of the fabric. The fabric comprises synthetic bicomponent polymer filaments, wherein the fabric has been calendered on at least one surface thereof to obtain a chintzed appearance. The fabric has an air permeability of less than 6 cubic centimeters per second per square centimeter, (cm³/cm²/sec), at 10 millimeters water gauge pressure.

### CROSS REFERENCE(S) TO RELATED APPLICATION(S)

This application claims benefit of priority from United Kingdom Patent Application 0217909.1 filed Aug. 1, 2002.

### BACKGROUND OF THE INVENTION

1. Field of the Invention

The present invention relates to a process for improving the stretch performance of fabrics, and to garments and other articles comprising improved fabrics produced by this process.

2. Description of the Related Art

In apparel applications, stretch fabrics of woven construction are known. However, none of these known fabrics is suited for outwear applications such as in light-weight fabric shells or in fabrics where low air permeability is desired. A particularly well-suited yam for making woven stretch fabrics is T-4OO™ Next Generation Fiber from E. I. du Pont de Nemours and Company Wilmington, Del. (hereinafter referred to as “DuPont”). This yarn, T-4OO™, is a self-crimping bicomponent polyester which brings elastification to fabrics without the use of spandex core filaments in the yam.

### SUMMARY OF THE INVENTION

The present inventors have found, surprisingly, that a fabric comprising a portion of synthetic polymer bicomponent filaments, especially T-400™ fiber, retains a high level of stretch and recovery while retaining a low level of air permeability achieved by calendering (“chintzing”). Calendering is a known technique for improving the wind resistance of certain fabrics through decreased air permeability, and for reducing the leakage of fibers through a fabric from a fibrous insulation layer. However, calendering has not hitherto been applied for the improvement of these properties when used in combination with stretch fabrics and especially fabrics from fibers which self-crimp due to their bicomponent structure.

It is an object of the present invention to provide fabrics comprising a portion of self-crimping bicomponent filament yarns wherein such fabrics have a chintzed appearance obtained by calendering. At the same time, a fabric stretch and recovery property is imparted through the function of self-crimping bicomponent filament yarns which is not sacrificed as a result of calendering.

It is a further object of the present invention to provide fabrics exhibiting high stretch and low air permeability, or wind resistance, simultaneously.

In a first aspect, the present invention provides a fabric comprising at least a region consisting of a single thickness of a fabric, wherein the fabric comprises synthetic polymer bicomponent filaments, the fabric having been chintzed on at least one surface thereof. The chintzed fabric is further characterized by an air permeability, determined as hereinafter described, of less than 6 cubic centimeters per second per square centimeter, (cm³/cm²/sec), at 10 millimeters water gauge pressure.

### DETAILED DESCRIPTION OF THE PREFERRED EMBODIMENTS

Preferably, the fabric consists substantially of a single thickness of the fabric, for example a single thickness article or garment. In certain embodiments, the fabric is chinized on only one side, and this side may be the side of the garment that is worn next to the body. The term “single thickness” refers to a single woven textile filaments. Preferably, the fabric has a weight in the range of 20 to 400 grams/m², more preferably 50 to 200 grams/m². Preferably, the fabric has an air permeability, determined as hereinafter described, of less than 6 cubic centimeters per second per square centimeter, (cm³/cm²/sec), at 10 millimeters water gauge pressure. More preferably, the fabric air permeability is less than 2 cm³/cm²/sec.

The fabric comprises synthetic filaments, and preferably it consists of synthetic-bicomponent filaments. The fibers of the invention are termed “bicomponent” fibers and are comprised of at least two polymers adhered to each other along the length of the fiber, each polymer being of the same generic class, e.g., polyamide polyester. Bicomponent fibers within the scope of the invention are melt spun from molten polymers of the same generic class and may be prepared using pre-coalescence or post-coalescence spinneret plates of the type known in the art. Preferably, the synthetic bicomponent filament component polymers are thermoplastic; more preferably, the synthetic bicomponent filaments are melt spun, and most preferably the component polymers are selected from the group consisting of polyesters and polyamides. The preferred polyester component polymers include polyethylene terephthalate (PET), polytrimethylene terephthalate (PTT) and polyletrabutylene terephthalate. Preferred polyamide component polymers are nylon 6, nylon 66, nylon 46, nylon 7, nylon 10, nylon 11, nylon 1610, nylon 612, nylon 12 and mixtures and copolyamides thereof. Especially preferred copolyamides include nylon 66 with up to 40 mole per cent of a polyadipamide wherein the aliphatic diamine component is selected from the group of DYTEK A® and DYTPK EP®. Both of these diamines are available from DuPont The more preferred polyester bicomponent filaments comprise a portion of PET polymer and a portion of PTT polymer, both portions of polymers are in a side-by-side relationship as viewed in the cross section of the individual filament. An especially advantageous filament yarn meeting this description of the more preferred polyester bicomponent is T-400™ Next Generation Fiber from DuPont. The more preferred polyamide bicomponent filaments comprise a portion of nylon 66 polymer or copolyamide having a first relative viscosity and a portion of nylon 66 polymer or copolyamide having a second relative viscosity, wherein both portions of polymer or copolyamide are in a side-by-side relationship as viewed in the cross section of the individual filament.

Preferably, the synthetic filaments comprise a UV absorbent material, and more preferably they comprise titanium dioxide particles. Preferred TiO₂ particles are of a size to function also as a delusterant (preferably 0.3 to 1 micrometer) and preferably they are present at a weight concentration of from 0.1 to 4 wt. %, more preferably from 0.5 to 3 wt. %. Alternatively or additiohally, the polymers may include other additives, for example ultraviolet light absorption, such as: CYASORB® UV-3346, -1164, -3638, -5411; and TINUVIN® 234 in amounts of about 0.1 to 0.3 percent by weight.

The fabric in the garments according to the invention is calendered on at least one side. Calendering (chintzing) of fabrics is performed by applying neat and pressure to at least one surface of the fabric. Calendered surfaces are readily identified by the characteristic plastic deformation of the surface. The calendering temperature is preferably maintained in a range from 140° C. to 195° C. The calendering temperature is more preferably maintained at 150° C. The calendering pressure is preferably 50 tonnes/sq. inch (6.5×10⁶ N/m²) (+/−10%) and the calendering is preferably performed at a speed in a range from 4 to 24 meters per minute, and preferably in the range of 8 to 14 meters per minute.

Calendering is preferably carried out using a two roll nip. A first roll of the nip is typically a hard, smooth heated surface such as heated stainless steel. A second roll is typically unheated and often covered with nylon/wool or optionally paper covered. Calendering equipment of this type is available from Kusters Textile Machinery Corporation, of Spartanburg, S.C.

As will be illustrated in more detail by the examples below, the present inventors have found a reduction in the air permeability of the fabrics of the invention as a direct result of calendering achieved without a sacrifice in the stretch and recovery of the fabric. It is surprising that the stretch properties of these fabrics and the chintz finish obtained through calendering are strongly expressed and independently achievable in the final fabric. This observation of fabric property independence after calendering is heretofore unknown and contrary to what the skilled person would predict concerning the maintaining of fabric stretch after a calendering process.

Specific embodiments and procedures of the present invention will now be described further, by way of example, as follows.

Measurement of Fabric Stretch

Fabric stretch and recovery for a stretch woven fabric is determined using an INSTRON universal electromechanical test and data acquisition system (available from: Instron Corp, 100 Royall Street, Canton, Mass., 02021 USA) to perform a constant rate of extension tensile test.

Two fabric properties are measured using the INSTRON: available fabric stretch and the fabric growth. The available fabric stretch is the amount of elongation caused by a specific load between 0 and 30 Newtons and expressed as a percentage change in length of the original fabric specimen as it is stretched at a rate of 300 mm per minute. The fabric growth is the unrecovered length of a fabric specimen which has been held at 80% of available fabric stretch for 30 minutes then allowed to relax for 60 minutes. Where 80% of available fabric stretch is greater than 35% of the fabric elongation, this test is limited to 35% elongation. The fabric growth is then expressed as a percentage of the original length.

The elongation or maximum stretch of stretch woven fabrics in the stretch direction is determined using a 3 cycle test procedure. The maximum elongation measured is the ratio of the maximum extension of the test specimen to the initial sample length found in the third test cycle at load of 30 Newtons. This third cycle value corresponds to hand elongation of the fabric specimen. This test is performed using the INSTRON tensile testerspecifically equipped for the three cycle test.

Measurement of Fabric Air Permeability

Air permeability of the fabric was measured using a Shirley Air Permeability Tester, model M021, available from:

Shirley Developments Ltd.

PO Sox 6,

856 Wilmshaw Road

Manchester M20 BSA England

This instrument, and the associated method of operation provided by the manufacturer, were designed to meet British Standard BS.5636:1978. This differs from the later standard BS EN ISO 9237: 1995 essentially only in the units used for expressing airflow (cubic centimeters per second, instead of cubic decimeters per minute), air pressure (millimeters water gauge, instead of Pascals) and the final calculated permeability (cubic centimeters of air per second per square centimeter of fabric area, instead of millimeters per second).

The principle of the test method is to measure the flow of air drawn through a given area of fabric under a specific pressure difference. On this particular instrument, the circular sample area has an area of 5.07 square centimeters. Final results are calculated for an area of one square centimeter. Measurements were made at a pressure of 10 mm water gauge, and the final permeability results quoted are for this specific differential pressure. A feature of the instrument is that it has a “guard ring device” around the sample area, as mentioned as an option in BS EN ISO 9237 :1995, to prevent air leakage through the sages of the sample; this feature was used during the measurements.

The instrument is calibrated once per year, as recommended in BSEN ISO 9237 1995, and is checked against capillary resistance standards each time before use.

Briefly, the method is as follows.

Fabric was conditioned adjacent to the instrument for a period exceeding 16 hours, at the standard laboratory conditions of 20° C, +/−2° C., and a relative humidity of 65%, +/−5%. The fabric was laid across the sample holder, flat without creasing, but also without stretching, and then clamped in place. The differential pressure across the fabric was adjusted to 10 mm water gauge. The differential pressure through the guard ring was also adjusted to 10 mm water gauge. This affects the fabric pressure stightly, so that continuing fine adjustments were made until both pressure gauges indicated 10 mm of water. The air flow through the fabric was then read from the flow meter, in cubic centimeters per second. This constitutes one measurement. A total of 10 separate measurements were made, each one on a different part of the fabric. Finally, the recorded air flows were divided by 5.07 (to reduce them to flow per square centimeter), and the mean value and standard deviation were calculated.

Final permeability was expressed in units of cubic centimeters of air per square centimeter of fabric area per second, (cm³/cm²/sec) at a differential pressure of 10 mm water gauge.

### EXAMPLE OF THE INVENTION

Fabrics were woven on a Sulzer Ruti 5100 air-jet loom, with a standard nylon 66 warp of 44 decitex and 34 filaments (known as T6342 yam, available from DuPont); this yam was fully dull containing 1.55 weight % TiO₂. The weft yam was an 83 decitex (34 filaments) T-400™ (DP002) elastic polyester yam from DuPont. Fabric construction was 55 warp threads per centimeter and 49 weft threads per centimeter in the loom. The fabrics were scoured and calendered to a woven intensity of 58/cm×51/cm. The calendering process was carried out using a two roll nip from Kusters Textile Machinery Corporation. The first roll of the nip was heated stainless steel and the second roll was unheated and covered with nylon/wool. The calendering temperature was 150° C. The calendering pressure was about 50 tonnes/sq.inch (6.5×10⁶ N/m²) (+/−10%), and the calendering was performed at a speed of 12 meters per minute.

The measured stretch available and stretch growth along with the air permeability values are reported in the following Table. This fabric had a chintz finish and a low air permeability, yet retained a high stretch (ca. 20%) and recovery property entirely suitable for use in stretch fabric applications.

TABLE

| | 1.04 cm³/cm²/sec |
|---|---|
| Permeability to air determined a | (Standard deviation, 0.19) |
| hereinbefore described | @ 10 mm water differential pressure |
| Available fabric stretch | 20.19% |
| Fabric stretch growth | 2.9% |
| (percent unrecovered stretch) | |

The example is for the purpose of illustration only. Many other embodiments falling within the scope of the accompanying claims will be apparent to the skilled person.

What is claimed is:

1. A fabric comprising synthetic bicomponent filaments, wherein the fabric has been calendered on at least one surface thereof and the fabric has an air permeability, determined as hereinbefore described, of less than 6 cubic centimeters per second persquare centimeter. (cm³/cm²/sec), measured at a static pressure of 10 millimeters of water.

2. A fabric according to claim 1, wherein the fabric has a weight of less than 400 grams/m², preferably 20 to 200 grams/m².

3. A fabric according to claim 1, wherein the synthetic bicomponent filaments are selected from the group consisting of polyester filaments, polyamide filaments and mixtures thereof.

4. A fabric according to claim 1, wherein the synthetic bicomponent filaments comprise polymers selected from the group consisting of polyethylene terephthalate, polytrimethylene terephthalate and polytetrabutylene terephthalate.

5. A fabric according to claim 1 ,wherein the synthetic bicomponent filaments comprise polymers selected from the group consisting of nylon 6, nylon 66, nylon 46, nylon 7, nylon 10, nylon 11, nylon 610, nylon 612, nylon 12 and mixtures and copolyamides thereof.

6. A fabric according to claim 1 , wherein at least a portion of the synthetic filaments comprises a UV absorbent additive.

7. A fabric according to claim 6, wherein the UV absorbent additive comprises titanium dioxide particles at a weight concentration of from 0.1 to 4 wt. %, preferably from 1 to 3 w %.

8. A fabric according to claim 1, wherein the fabric comprises at least a region consisting of a single thickness.

9. An article comprising a fabric according to claim 1.
